(19) United States
(12) Patent Application Publication
(10) Pub. No.: US 2016/0012427 A1
(43) Pub. Date: Jan. 14, 2016

(54) SYSTEMS AND METHODS FOR AUTHENTICATING USERS OF NETWORKED COMPUTER SYSTEMS BASED ON NON-CREDENTIALED INFORMATION

(71) Applicant: The Toronto-Dominion Bank, Mississauga (CA)

(72) Inventors: Lauren VAN HEERDEN, Bedford, NH (US); Orin DEL VECCHIO, Richmond Hill (CA); Gunalan NADARAJAH, Milton (CA); Paul Mon-Wah CHAN, Markham (CA); Jonathan K. BARNETT, Oakville (CA); Jakub DANIELAK, Toronto (CA); Roisin FRITZ, Toronto (CA); John Jong Suk LEE, Waterloo (CA); Hashmi T. SHAKILA, Toronto (CA)

(73) Assignee: The Toronto-Dominion Bank

(21) Appl. No.: 14/795,584

(22) Filed: Jul. 9, 2015

Related U.S. Application Data
(60) Provisional application No. 62/022,470, filed on Jul. 9, 2014.

(51) Int. Cl. G06Q 20/38; G06Q 50/00; H04L 29/06

(52) U.S. Cl. CPC G06Q 20/382; H04L 63/08; G06Q 50/01

(57) ABSTRACT

The disclosed embodiments include computerized methods and systems for authenticating user identity based on non-credentialed information. For example, in response to a request from a device of a user for a service performable by one or more networked computer systems, the disclosed embodiments may identify one or more public and private sources of non-credentialed information. The disclosed embodiments may also transmit messages to devices of the individuals requesting non-credentialed information associated with the user, and based on the received responses, may verify an identity of the user based on at least a portion of the received non-credentialed information. Further, in some aspects, non-credentialed authentication processes consistent with the disclosed embodiments may reduce an ability of malicious parties to attach or hack into the one or more networked computer systems.

### CROSS-REFERENCE TO RELATED APPLICATIONS

This application claims the benefit of U.S. Provisional Patent Application No. 62/022,470, filed Jul. 9, 2014, which is expressly incorporated by reference herein, in its entirety.

### BACKGROUND

1. Technical Field

The disclosed embodiments generally relate to computerized systems and methods for user authentication, and more particularly, and without limitation, to computerized systems and methods that securely verify an identity of a user using public and private sources of non-credentialed information.

2. Background

Today, many financial institutions require existing and potential customers to establish their identity or other personal characteristics prior to performing a requested financial services transaction, such as opening a new checking or savings account. Customers typically establish their identities through paper documents, such as government-issued forms of identification (e.g., driver's licenses or passports), utility bills, copies of leases or deeds, and other proofs of residence. The need to maintain a wide variety of paper documents and physical items to prove identity and personal attributes is a cumbersome process not only for existing customers of a financial institution, but also for new customers, recent immigrants, students, and other-under-banked cohorts that may lack the breadth of documentation needed to verify identity. For example, potential customers who have recently relocated may be unable to provide certain credentialed information, such as a recent utility bill at a new residence. Recent immigrants from other countries may have even more difficulty providing credentialed information, as they may not yet have obtained government-issued identification.

Further, conventional authentication processes that rely on non-credentialed information are often subject to attack by malicious parties. These malicious parties may repeatedly and continuously participate in these conventional authentication processes (e.g., through daisy-chained attacks) in order to fraudulently verify identifies of corresponding ones of the malicious parties (which themselves may vouch for identities of additional parties) in order to attack secure computer systems. Further, conventional authentication processes that rely on non-credentialed information often facilitate communication between individuals requesting authentication and sources of the non-credentialed information, thus introducing bias into the authentication process and reducing an accuracy of the authentication process.

### SUMMARY

The disclosed embodiments include, a computer-implemented method that receives, by one or more processors, a request for a financial services transaction from a user, and identifying, by the one or more processors, one or more individuals having knowledge of the user. The method may include transmitting, by the one or more processors, one or more messages to the individuals requesting non-credentialed information associated with the user, and receiving, by the one or more processors, the non-credentialed information from the one or more individuals in response to the transmitted messages. The method may further include determining, by the one or more processors, whether to verify the identity of the user based on at least a portion of the received non-credentialed information.

The disclosed embodiments may also include a system that includes a storage device and at least one processor coupled to the storage device. The storage device may store software instructions for controlling the at least one processor when executed by the at least one processor. The at least one processor may be operative with the software instructions and may be configured to receive a request for a financial services transaction from a user. The at least one processor may be further configured to identify one or more individuals having knowledge of the user, and transmit one or more messages to the individuals requesting non-credentialed information associated with the user. The at least one processor may be further configured to receive the non-credentialed information from the one or more individuals in response to the transmitted messages. The at least one processor may be further configured to determine whether to verify the identity of the user based on at least a portion of the received non-credentialed information.

In other embodiments, a tangible, non-transitory computer-readable medium may store instructions that, when executed by at least one processor, cause the at least one processor to perform a method that includes receiving a request for a financial services transaction from a user, and identifying one or more individuals having knowledge of the user. The method may include transmitting one or more messages to the individuals requesting non-credentialed information associated with the user, and receiving the non-credentialed information from the one or more individuals in response to the transmitted messages. The method may further include determining whether to verify the identity of the user based on at least a portion of the received non-credentialed information.

It is to be understood that both the foregoing general description and the following detailed description are exemplary and explanatory only, and are not restrictive of the disclosed embodiments as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 depicts an exemplary computing environment consistent with disclosed embodiments.

FIG. 2 depicts a flowchart of an exemplary process for confirming an identity using non-credentialed information consistent with disclosed embodiments.

### DESCRIPTION OF THE EMBODIMENTS

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

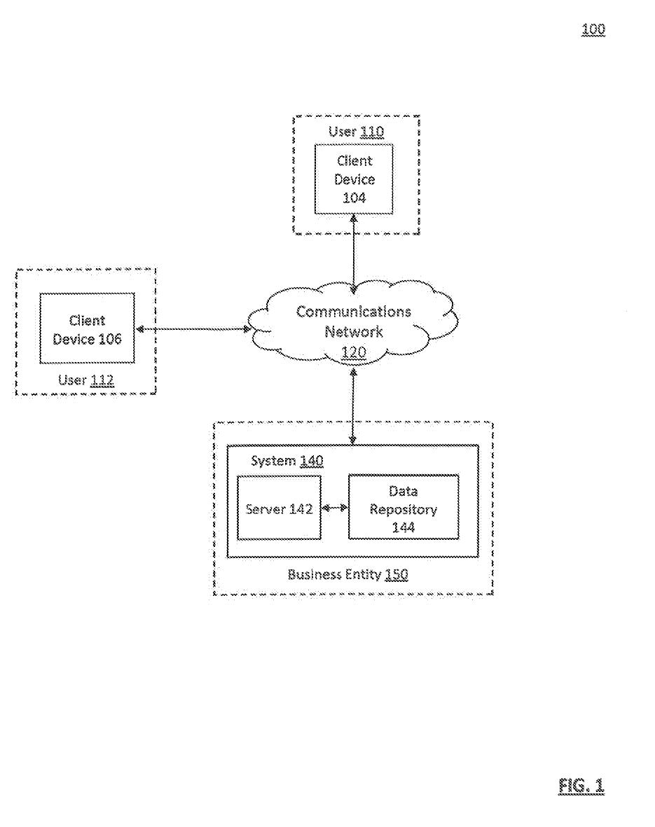

FIG. 1 illustrates an exemplary computing environment 100 consistent with certain disclosed embodiments. In one aspect, computing environment 100 may include client devices 104 and 106, a system 140, and a communications network 120 connecting one or more of the components of environment 100.

In one embodiment, client devices 104 and 106 may be computing devices, such as, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on a display device(s), consistent with disclosed embodiments. In certain embodiments, client devices 104 and 106 may be associated with one or more users, such as users 110 and 112. For instance, user 110 may operate client device 104 and may do so to cause client device 104 to perform one or more operations consistent with the disclosed embodiments. In some aspects, one or more of client devices 104 and 106 may include a smart card, chip card, integrated circuit card (ICC), and/or other card having an embedded integrated circuit. By way of example, systems consistent with the disclosed embodiments (e.g., system 140) may be configured to track one or more secured locations accessed by user 110 (e.g., a street entrance to a secured apartment building) using a smart card incorporated into client device 104.

Client devices 104 and 106 may include known computing device components. For instance, client device 104 may include one or more tangible, non-transitory memories that store data and/or software instructions, and one or more processors configured to execute software instructions. Client device 104 may include one or more display devices that display information to a user and one or more input device(s) to allow the user to input information to client device 104 (e.g., keypad, keyboard, touch screen, voice activated control technologies, or any other type of known input device).

In one aspect, client devices 104 and 106 may store in memory one or more software applications that run on client device 104 and are executed by the one or more processors. For instance, client device 104 may store software applications that, when executed by one or more processors, perform operations that allow user 110 (through client device 104) to interact with business entity 150, through, for example, a computing device, such as server 142 or other computing component(s) of system 140. In certain aspects, additional software applications may, when executed by client device 104, cause client device 104 to send information to be stored in a memory remote to client device 104 and/or receive information stored in a memory remote to client device 104 (e.g., memory associated with server 142, such as data repository 144). The disclosed embodiments are, however, not limited to such exemplary configurations, and in further embodiments, client device 104 may be configured in any additional or alternate manner to enable communication and data exchange with system 140 across network 120.

Business entity 150 may, for example, be any type of business entity that may provide financial account(s) to one or more users (e.g., customers of business entity 150). For example, business entity 150 may be a financial institution, such as a commercial bank, an investment bank, a provider of a payment instrument or financial service accounts, etc. In some embodiments, a financial service account may be a checking, savings, credit, debit, prepay, and/or a reward or loyalty account, and a payment instrument may include, but is not limited to, a personal or corporate credit card, a debit card, a prepaid credit or debit card, or a check instrument.

Further, in certain aspects, users 110 and 112 may be customers or potential customers of business entity 150. In other aspects, user 110 may be a customer that holds or requests establishment of one or more financial accounts with business entity 150, such as a checking account, savings accounts, credit card account, debit accounts, line of credit accounts, and/or other types of accounts. In some aspects, user 112 may be a representative or employee of business entity 150 (e.g., a teller or other employee of the financial institution), and client device 106 may be disposed within a physical location of business entity 150 (e.g., a branch of the financial institution) disposed within a geographic region.

System 140 may be a computing system configured to execute software instructions to perform one or more operations consistent with disclosed embodiments. In one aspect, system 140 may be associated with business entity 150, e.g., a financial institution. System 140 may be a distributed system that may include computing components distributed across one or more networks, such as network 120, or other networks.

In one aspect, system 140 may include computing components known to those skilled in the art and configured to store, maintain, and generate data and software instructions. For example, system 140 may include one or more servers (e.g., server 142) and tangible, non-transitory memory devices (e.g., data repository 144). Server 142 may include one or more computing devices (e.g., servers) that may be configured to execute software instructions to perform one or more processes consistent with the disclosed embodiments. In one example, server 142 may be a computing device that executes software instructions that perform operations that provides information to one or more other components of computing environment 100. In one embodiment, server 142 may include computing device (e.g., a personal computer, network computer, server, or mainframe computer) having one or more processors that may be selectively activated or reconfigured by a computer program. In one aspect, server 142 (or other computing components of system 140) may be configured to provide one or more websites, digital portals, etc., that provide services consistent with business entity 150, such as an digital banking portal, and services consistent with disclosed embodiments. For instance, server 142 may be configured to provide information associated with a requested web page over communications network 120 to client device 102, which may render the received information and present content from the web page on a display device. Additionally, server 142 may be incorporated as a corresponding node in a distributed network, and additionally or alternatively, as a corresponding networked server in a cloud-computing environment. Furthermore, server 142 may communicate via network 120 with one or more additional servers (not shown), which may facilitate the distribution of processes for parallel execution by the additional servers.

In other aspects, system 140 may also be configured to initiate and execute one or more financial services transactions, which include, but are not limited to, an establishment of a checking, savings, investment, and/or brokerage account, an application for credit, a transfer of funds between financial accounts (e.g., checking, savings, investment, etc.), a deposit or withdrawal of funds, a purchase or sale of a financial instrument or security, a purchase or sale of goods or services, or a payment of a bill. In one embodiment, client devices 104 and 106 may exchange information and parameters facilitating execution of one or more transactions associated with system 140 (e.g., through one or more websites and/or digital portals presented by client device 104).

Data repository 144 may include one or more memories that are configured to store and provide access to data and/or software instructions. Such memories may include tangible non-transitory computer-readable media that store software instructions that, when executed by one or more processors (e.g., of server 132), perform one or more operations consistent with disclosed embodiments. Data repository 144 may also be configured to store information relating to business entity 150. In certain aspects, data repository 144 may be configured to store data identifying one or more customers of business entity 150 (e.g., customer data), financial account data associated with the customers (e.g., account data), data identifying transactions involving one or more customers of business entity 150 (e.g., transaction data), and data indicative of current and past digital activities of the customers (e.g., digital activity data).

Although computing environment 100 is illustrated in FIG. 1 with client devices 104 and 106 in communication with system 140, persons of ordinary skill in the art will recognize that environment 100 may include any number of number of mobile or stationary client devices 104 and 106, and any additional number of computers, systems, or servers without departing from the spirit or scope of the disclosed embodiments. Further, although computing environment 100 is illustrated in FIG. 1 with a single business entity 150 and/or system 140, persons of ordinary skill in the art will recognize that environment 100 may include any number of additional number of business entities and corresponding systems, any number of additional number of servers and data repositories, and any additional number of computers, systems, servers, or server farms without departing from the spirit or scope of the disclosed embodiments.

Communications network 120 may include one or more communication networks or medium of digital data communication. Examples of communication network 120 include a local area network (“LAN”), a wireless LAN, a RF network, a Near Field Communication (NFC) network, (e.g., a “WiFi” network), a wireless Metropolitan Area Network (MAN) connecting multiple wireless LANs, NFC communication link(s), and a wide area network (“WAN”), e.g., the Internet. Consistent with embodiments of the present disclosure, communications network 120 may include the Internet and any publicly accessible network or networks interconnected via one or more communication protocols, including, but not limited to, hypertext transfer protocol (HTTP) and transmission control protocol/internet protocol (TCP/IP). Communications protocols consistent with the disclosed embodiments also include protocols facilitating data transfer using radio frequency identification (RFID) communications and/or NFC. Moreover, communications network 120 may also include one or more mobile device networks, such as a GSM network or a PCS network, allowing client device 104 to send and receive data via applicable communications protocols, including those described herein.

In some embodiments, system 140 may be configured to initiate and execute one or more financial services transactions on behalf of customers of a financial institution. By way of example, and in response to a request from a customer (e.g., user 110), system 140 may perform software processes that establish savings, checking, and/or investment accounts, establish lines of credit, initiate purchases and sales of securities, and/or perform electronic transfers of funds between accounts at the financial institution and other financial institutions. Further in some aspects, user 110 may request the one or more financial services transactions through an online portal or website associated with the financial institution and presented by client device 104, and additionally or alternatively, through a terminal disposed at a branch location of the financial institution (e.g., operated by a teller at the branch).

In certain aspects, system 140 may verify an identity of user 110 before performing the one or more financial services transactions requested by user 110. In an embodiment, and prior to performing the requested financial services transactions, system 140 may require that user 110 present, at a branch of the financial institution, documents (e.g., “credentialed information”) that establish user 110's identify and confirm user 110's place of residence. Credentialed information consistent with the disclosed embodiments may include, but is not limited to, a government-issued form of identification (e.g., driver's license, a passport, and/or a certificate of citizenship or naturalization), a utility bill listing user 110's place of residence, and/or another proof of residence (e.g., a lease of or deed to property).

In some instances, user 110 may be unable to provide the credentialed information necessary to enable system 140 to perform the requested financial services transactions. By way of example, user 110 may plan to move from Washington, D.C., to Toronto, Canada, and may wish to establish savings and checking accounts at a local financial institution to facilitate the planned relocation and graduate study. Prior to the planned relocation, however, user 110 may not possess any identification issued by the local government or any proof of local residence, and thus may be unable to produce the credential information required by the financial institution to open the requested checking and savings accounts.

Although lacking the sufficient credentialed information, user 110 may be linked to one or more individuals capable of providing the financial institution with confirmation of user 110's identity. For example, one or more social media networks (e.g., Facebook™, LinkedIn™, Instagram™, and/or Twitter™), professional organizations (e.g., AIPLA™, ASME™, etc.), and/or alumni associations (e.g., the Penn State Alumni Association™) may link user 110 with individuals capable of vouching for and/or guaranteeing user 110's identity. Further, by way of example, individuals that live proximate to user 110, that work for the same company as user 110, or that are employed by or are patrons of establishments and attractions frequented by user 110 may provide the financial institution with information that confirms user 110's identity. In some aspects, as described below, system 140 may be configured to authenticate the identity of user 110 using information, e.g., “non-credentialed” information, provided by one or more of these individuals and their relationships with user 110. The disclosed embodiments, as outlined below, enable system 140 of business entity 150 to securely authenticate an identity of a user 110 based on public and private sources of non-credentialed information, and overcome problems associated with conventional non-credentialed authentication processes, which are susceptible to daisy-chained attacks by malicious parties and inappropriate communications between user 110 and sources of the non-credentialed information.

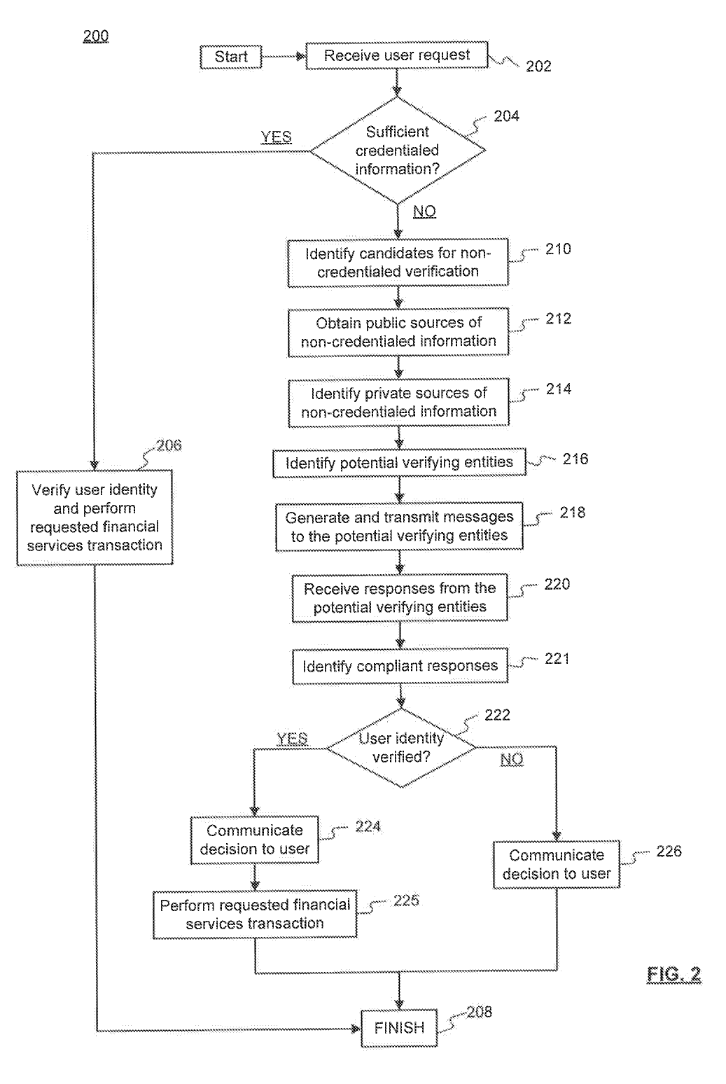

FIG. 2 illustrates an exemplary process 200 for verifying an identity of a customer based on non-credentialed information, in accordance with disclosed embodiments. In one aspect, a system associated with a financial institution (e.g., system 140 associated with business entity 150) may receive a request to perform one or more financial services transactions on behalf of a customer (e.g., user 110). In some aspects, system 140 may be configured to perform software processes that verify an identity of user 110 based on one or more elements of non-credentialed information provided by individuals (e.g., “potential verifying entities”) having knowledge of user 110, derived by system 140 from information provided by user 110, and/or identified by system 140 in response to the received request. System 140 may, in certain aspects, initiate and execute the requested financial services transactions in response to the verification of user 110's identity using non-credentialed information, either alone or in combination with elements of credentialed information.

In FIG. 2, system 140 may receive a request to perform one or more financial services transactions on behalf of user 110 (e.g., at step 202). By way of example, user 110 may, via client device 104, access a web page or other online portal associated with the financial institution, which may identify one or more types of financial services transactions provided by the financial institution (e.g., establishing new accounts, etc.). In some aspects, the presented web page or online portal may enable user 110 to apply for a new account at the financial institution (e.g., a checking account) by entering information within one or more presented forms. The information entered by user 110 may include, but is not limited to, basic personal information, such as name, birthdate, address, and/or employer name, as well as sources of credentialed information, such a driver's license number, if available. Based on the entered information, client device 104 may generate a request to establish the checking account, which may be transmitted to system 140 associated with the financial institution using one or more of the communications protocols outlined above.

In other aspects, user 110 may visit a physical. “brick and mortar” branch of the financial institution to apply for the new checking account. By way of example, user 110 may fill out a paper application for the new checking account, and a representative of the financial institution (e.g., user 112 of FIG. 1) may enter the application information into a web page or online portal presented by a device or terminal disposed at the branch (e.g., client device 106 of FIG. 1). Further, user 110 may also present one or more sources of credentialed information to the representative (e.g., a driver's license or proof of residence) for notation within the web page or online portal. Client device 106 may, in some instances, package the entered information as a request to establish the checking account, which client device 106 may transmit to system 140 using any of the techniques described above.

System 140 may receive the transmitted request, and in step 204, determine whether user 110 is associated with sufficient credentialed information to verify user 110's identity prior to performing the requested financial services transaction (e.g., establishing the requested checking account, etc.). In one embodiment, system 140 may determine the sufficiency of user 110's credentialed information based on one or more rules established by business entity 150 (e.g., the financial institution). The established rules may, for example, specify a number and/or a type of credentialed information required to verify user 110's identity, which may depend on a relationship between user 110 and the financial institution. By way of example, fewer elements of credentialed information may be required to authorize or confirm the identity of an existing user than to authorize or confirm the identity of a new user. Further, in some aspects, the number and/or the type of credentialed information required to verify user 110's identity may depend on a nature of the requested financial services transaction. For example, the established rules may require multiple elements of credentialed information (e.g., a valid government-issued form of identification and proof of residence, etc.) before system 140 opens (or closes) a checking, savings, or investment account on behalf of user 110. In other aspects, the established rules may require no credentialed information before system 140 performs an electronic transfer of funds between accounts of user 110 at the financial institution.

In certain aspects, system 140 may determine in step 204 whether the credentialed information previously provided by user 110 (e.g., presented to the representative of the financial institution) comports with the established rules for performing the requested financial services transaction (e.g., opening the new checking account). If user 110 provided sufficient credentialed information (e.g., step 204; YES), system 140 may verify the identity of user 110, and may be configured to perform software processes that open the requested checking account in accordance with one or more established procedures of the financial institution (e.g., in step 206). For example, in step 206, system 140 may verify the application information provided within the request (e.g., by accessing information within data repository 144 of FIG. 1), perform additional verification processes (e.g., receive information associated with a background or credit check by exchanging data with third-party computer systems in communication with system 140 over network 120), and generate, store, and communicate to client device 104 and/or 106 information describing the new checking account (e.g., by creating or modifying portions of files in data repository 144 representing an account number, a routing number, etc.). Exemplary process 200 is then complete in step 208.

If, however, system 140 determines that the credentialed information is missing or is insufficient to verify user 110's identity (e.g., step 204; NO), system 140 may identify user 110 as a candidate for verification using elements of non-credentialed information (e.g., in step 210). By way of example, the non-credentialed information may include, but is not limited to, information associated with and provided by individuals linked to or otherwise having relationships with user 110 through social media networks (e.g., Facebook™, LinkedIn™, Instagram™, and/or Twitter™), professional organizations (e.g., AIPLA™, ASME™, etc.), and/or alumni associations (e.g., the Penn State Alumni Association™). Further, by way of example, the non-credentialed information may identify individuals that live proximate to user 110, that work for the same company as user 110, or that are employed by or are patrons of establishments and attractions frequented by user 110 may providing the financial institution with information that confirms user 110's identity.

In some aspects, system 140 may obtain information identifying one or more “public” sources of non-credentialed information from user 110 (e.g., at step 212). By way of example, a public source of non-credentialed information may include an individual identified by user 110 as being capable of vouching for user 110's identity based on non-credentialed information. In some aspects, system 140 may generate a request for public sources of non-credentialed information from user 110, which may be transmitted to client device 104 (and additionally or alternatively, to a client device disposed within a branch of the financial institution) using one or more of the communications protocols outlined above.

Client device 104 (and additionally or alternatively, client device 106 disposed at the financial institution branch) may receive the transmitted request, and may render information associated with the request for presentation to user 110 within a corresponding web page or online portal. In certain aspects, the presented information may indicate that the system 140 is unable to verify user 110's identity based on credentialed information alone, and may request that user 110 provide one or more public sources of non-credentialed information to facilitate verification by system 140. Upon entry of the public sources into the web page or online portion, client device 104 may transmit the entered information to system 140, which may receive the information identifying the public sources from client device 104 in step 212.

In some embodiments, and as described herein, the public source information may include individuals and/or business entities capable of confirming the identity of user 110 by providing non-credentialed information. In one embodiment, the public source information may identify one or more social networks of user 110 (e.g., Facebook™, LinkedIn™, Twitter™, and/or Instagram™) and an identifier (e.g., a username, a handle, and/or a URL) associated with user 110 on each of the social networks. In some aspects, the identification of user 110's social networks and social network identifiers may enable system 140 to characterize a social networking relationship between user 110 and the identified public sources of non-credentialed information based on user 110's social networking activity.

In other aspects, system 140 may be configured to identify one or more public sources of non-credentialed information in step 212. By way of example, system 140 may receive, from client device 104 associated with user device 110, information identifying user 110 within one or more social media networks (e.g., a handle, login, or other identifier of user 110). The identifying information received from client device 104 may, for example, indicate to system 140 that user 110 grants business entity 150 (e.g., the financial institution) permission to access to the one or more social networks. In some instances, one or more components of system 140 (e.g., server 142) may be configured to associate the received identifying information with user 110 and store the associated identifying information within a corresponding portion of a data repository (e.g., data repository 144).

By way of example, and using at least a portion of the stored identifying information, server 142 may perform operations that access one or more social-networking profiles of user 110 (e.g., through application programming interfaces (APIs) maintained by networked social-networking systems), and obtain information identifying one or more additional users linked to user 110 through the one or more social networks. Server 142 may, in some instances, be configured to associate the obtained information with user 110 and store the associated information in a corresponding portion of data repository 144. In other aspects, server 142 may obtain information identifying the one or more additional users linked to user 110 and/or additional social-networking information by accessing, subscribing to, or otherwise receiving one or more data feeds provided by corresponding ones of the social-networking provider systems. Further, in additional instances, server 142 may be configured to determine whether any of the additional users granted permission for system 140 to access corresponding social-networking data, and if so, server 142 may be configured to obtain social-networking information associated with these additional users (e.g., information identifying further linked user, etc.) using any of the exemplary techniques described above.

In certain aspects, system 140 may be configured to execute software processes that access digital activity data of user 110 (e.g., as stored within data repository 144 of FIG. 1) and identify one or more individuals and/or business entities linked to user 110 within corresponding social media networks. In additional aspects, system 140 may also be configured to identify, based on the accessed digital activity data, one or more individuals that attended a university in common with user 110, that work for a common employer, and further, that may belong to a common professional or alumni association.

In some embodiments, the public sources of non-credentialed information identified by system 140 may augment those identified by user 110 and generate list of public sources suitable for and/or consistent with requirements established by a financial institution associated with system 140. By way of example, the financial institution may require that user 110 identify a predetermined number of public sources (e.g., as received by system 140 in step 212, above). In some instances, user 110, through client device 104, may provide system 140 with information identifying an insufficient number of public sources, and system 140 may be configured to identify one or more additional public sources that provide the required predetermined number. In other aspects, however, system 140 may be configured to execute software processes that identify any number of public sources of non-credentialed information in step 212, with or without public sources provided to system 140 by user 110 through client device 104.

Further, in additional embodiments, the public source information may include names, email addresses, residential addresses, and/or telephone numbers for the identified individuals, as well as information regarding user 110's relationship with the identified individuals. For example, the relationship information may specify, for the identified individuals, a duration of the relationship, a nature of the relationship (e.g., social networking, professional organization, alumni network, coworker, spouse, parent, child, college friend, minister), and documents evidencing the customer's relationship with the identified person (e.g., marriage certificate, college transcript, press release).

In other aspects, the public sources may also include one or more business entities that may be able to confirm the identity of user 110. For example, user 110 may identify, as a public source of non-credentialed information, a specific retail location of Starbucks™ from which user 110 frequently purchases coffee and pastries.

System 140 may also identify one or more “private” sources of non-credentialed information that are capable of providing non-credentialed information to verify user 110's identity (e.g., at step 214). In certain aspects, the private sources of non-credentialed information include individuals and business entities identified by system 140 based on, for example, information provided by user 110 when identifying the public sources of non-credentialed information, and additionally or alternatively, information associated with user 110 and included within the received request (e.g., at step 202). In further aspects, private sources of information consistent with the disclosed embodiments may include, but are not limited to, customers of business entity 150 (e.g., the financial institution), employees of the financial institution, business entities associated with the financial institution (e.g., vendors, consultants, etc.), and employees of these associated business entities. In some aspects, described below, system 140 may establish level of “trust” for these private sources of non-credentialed information that reflects the relationship between these private sources and the financial institution (e.g., business entity 150).

By way of example, system 140 may identify user 110's place of employment based on the received request, and may access one or more data stores (e.g., the account data stored in data repository 144 of FIG. 1) to identify customers of the financial institution that share a place of employment with user 110 and may be capable of verifying user 110's identity. Further, for example, system 140 may identify user 110's home address based on information provided in the received request, and may access one or more of the data stores to identify customers of the financial institution that reside within a threshold distance of user 110's home, in the same neighborhood or residential subdivision as user 110, and/or in the same apartment, condominium, or co-op building as user 110. Further, in some instances, a representative of the financial institution may serve as a private source of non-credentialed information for a user, if the employee knows user 110 and is capable of acting as a guarantor of user 110's identity.

Further, and as described above, one or more customers of the financial institution may be associated with client devices that incorporate smart cards, In certain aspects, system 140 may be configured to access tracking data indicative of secured locations accessed by the customer's smart cards, and may establish one or more of the customers as private sources of non-credentialed information based on the tracking data in step 214. By way of example, system 142 may determine that one or more of the customers accessed a secured entry to an apartment building inhabited by user 110, and may establish the determined customers as private sources in step 214.

In some aspects, system 140 may be configured identify one or more of the private sources of non-credentialed information based on a determined proximity of these sources to user 110. By way of example, client device 104 may include an on-board positioning system (e.g., a global positioning system (GPS) unit or sensor) capable of detecting a current geographic location of client device 102 (and thus, user 110) at regular or predetermined intervals. Client device 104 may, in some instances, be configured to include within the request to perform the one or more financial services transactions positional information identifying user 110's current spatial position (e.g., within a header or a footer of a corresponding packetized request). Upon receipt of the request from client device 104 (e.g., in step 202) system 140 may be configured to parse the received request and extracted the embedded positioning information, which reflects user 110's current geographic location.

Further, in certain aspects, system 140 may be configured to obtain positional information identifying current geographic locations of one or more individuals known by the financial institution. These individuals include, but are not limited to, customers of the financial institution, employees of the financial institution, employees of business entities related to the financial institution, and/or individuals that previously and successfully verified user identifies for the financial institution, as described below. In some instances, system 140 may be configured to receive positional data identifying the current geographic locations of these known individuals from corresponding devices (e.g., as detected by on-board GPS units or sensors) and additionally or alternatively, from external positioning systems, at regular intervals or in response to specific requests. System 140 may, for example, receive the positional data from the devices and/or the external positioning system, may associate the received positional information with corresponding ones of the known individuals, and store the positional information and information identifying the associated individuals in data structures within data repository 144.

In an embodiment, system 140 may be configured to select one or more of the individuals as private sources of non-credentialed based on a proximity of these known individuals to user 110. For example, based on the received positional information, system 140 may be configured to detect that a device associated with one of the individuals (e.g., a customer of the financial institution, an employee of the financial institution, a prior guarantor, etc.) is disposed within a threshold distance of client device 104 (e.g., one meter, two meters, etc.). Further, by way of example, and based on the received positional information, system 140 may detect that the individual's device and client device 104 are each disposed within the same business entity (e.g., a physical branch of the financial institution, a retailer location, etc.). In certain aspects, and in response to the detected proximity of the individual's device to client device 104, system 140 may be configured to select the individual as one of the private sources of non-credentialed information (e.g., in step 214).

In other embodiments, system 140 may identify one or more sources of non-credentialed information based on data indicative of prior purchase transactions requested and/or initiated by user 110 and other customers of the financial institution. For instance, as described above, system 140 may maintain data records (e.g., in a portion of data repository 144) that include information characterizing one or more purchase transactions involving accounts (e.g., debit card account, credit card accounts, etc.) held by user 110 and other customers of the financial institution. For example, user 110 may initiate a purchase transaction at a location of particular merchant using a credit card account issued by the financial institution. System 140 may, in some instances, generate and store transaction data (e.g., in data repository 144). Transaction data consistent with the disclosed embodiments may include, but is not limited to, information identifying the particular merchant, the geographic location of the purchase (e.g., based on positional information provided by a corresponding point-of-sale device), user 110, the purchase amount, the credit card account, and a confirmation number associated with the transaction.

In some aspects, system 140 may be configured to access the stored transaction data (e.g., within data repository 144), and determine that user 110 and an additional customer initiated transactions involving a purchase of a good or service from a common retailer. In one embodiment, system 140 may be configured to determine that the purchase transactions of user 110 and the additional customer each occur during a predetermined temporal window prior to user 110's request for the financial services transaction (e.g., within the last twenty-four hours, forty-eight hours, etc.). Additionally or alternatively, system 140 may be configured to determine that the purchase transactions of user 110 and the additional customer are initiated within a threshold time period (e.g., one minute, five minutes, etc.) of each other. In some aspects, and in response to these determinations, system 140 may identify the additional customer as a private source of non-credentialed information capable of verifying an identity of user 110.

The pre-determined temporal window and/or the threshold time period may be established by the financial institution (e.g., business entity 150) and/or system 140 to ensure that the transactions are sufficiently recent that user 110 and/or the additional customer may remember the transaction and further, that the additional customer may recognize user 110. Further, in some aspects, system 140 may adaptively determine the pre-determined temporal window and/or the threshold time period based on characteristics of the merchant, characteristics of user 110 and/or the additional customer and/or characteristics of the purchase transactions.

For example, user 110 may request (e.g., through an interface presented by client device 104) performance of a financial services transaction by the financial institution (e.g., business entity 150) on Jul. 1, 2015. Further, by way of example, user 110 and an additional customer of the financial institution may be in line at a local Starbucks™, and may initiate purchases of coffee from the local Starbucks™ within a five-minute period. As described above, system 140 may be configured to access the stored transaction data to determine that user 110 and the additional customer initiated purchase transactions at the common retailer (e.g., the local Starbucks™) within a pre-determined threshold time period (e.g., two days prior to the requested financial services transaction). System 140 may also determine that the purchase transactions at the common retailer occurred within a threshold time period (e.g., five minutes) of each other. In an embodiment, and in response to these determinations, system 140 may establish the additional customer as one of the private sources of non-credentialed information (e.g., in step 214).

In step 216, system 140 may filter the public and private sources of non-credentialed information to generate a set of individuals and business entities, e.g., potential “verifying entities,” capable of guaranteeing and verifying user 110's identity to the financial institution. In some aspects, system 140 may identify the potential verifying entities based on a degree and/or type of connection between user 110 and the public and private sources, based on a level of “trust” assigned to the public and private sources by system 140, based on a status of the public and private sources as prior guarantors of user identity to the financial institution, and further, based on relationships between positional data associated with user 110 and the public and private sources.

In certain aspects, in step 216, system 140 may access social media information associated with user 110 (e.g., stored within data repository 144 of FIG. 1, accessed from one or more external social media aggregators, and/or obtained from one or more data feeds provided by social-networking systems) and identify types and numbers of social media connections between user 110 and the public and private sources. System 140 may, for instance, filter the public and private sources to retain as potential verifying entities those public and private connected to user 110 through a threshold number of social networking links (e.g., five or more links). In other aspects, system 140 establish a public or private source as a potential guarantor when that public or private source is linked to user 110 through a single social media network (e.g., Facebook™, LinkedIn™, or Instagram™), or alternatively, through two or more social networks (e.g., Facebook™ and LinkedIn™, or Facebook™ and Instagram™).

In other aspects, system 140 may identify one or more of the public and private sources as potential verifying entities based on a nature of the social networking relationships between user 110 and the public and private sources. For example, system 140 may establish a public or private source as a potential guarantor when that public or private source is mentioned within a threshold number of user 110's posts on Facebook™ or tweets on Twitter™. In other aspects, system 140 may identify a public or private source as a potential guarantor when that public or private source is tagged or mentioned in a threshold number of user 110's pictures posted on Facebook™, Twitter™, or Instagram™.

In other embodiments, system 140 may favor certain social media connections when identifying the potential verifying entities. For example, system 140 may favor a public or private source with a two-way connection with user 110 on Twitter™ (e.g., the public or private source follows and is followed by user 110) as a potential guarantor over a public or private source having a one-way connection with user 110 on Twitter™ (e.g., the public or private source follows user 110, but is not followed by user 110). In further embodiments, system 140 may identify a public or private source as a potential guarantor when the public or private source and user share a threshold number of mutual friends and/or mutual connections, as reflected in one or more of user 110's social networks.

Additionally or alternatively, system 140 may be configured to identify potential verifying entities that are linked to user 110 through one or more social networks, and further, are associated with client devices currently disposed within a threshold displacement of a location of client device 104. By way of example, system 140 may identify potential verifying entities linked to user 110 through the threshold number of social media connections, and may execute one or more location-based services to identify and/or receive current geographic positions of client device 104 and the client devices associated with the potential verifying entities. In some instances, system 140 may identify one or more of the potential verifying entities whose client devices are disposed within a predetermined distance of client device 104. A potential verifying entity may, for example, be capable of observing user 110 when a corresponding client device falls within the predetermined distance of client device 104.

In some aspects, system 140 may also identify the potential verifying entities based on levels of “trust” assigned to the public and private sources non-credentialed information by system 140. The assigned trust levels may, for example, indicate an extent to which the financial institution trusts the guarantee of user 110's identity provided by the public and private sources.

For example, system 140 may assign a level of trust to a public or private source of non-credentialed information based on a certification provided to that public or private source by a governmental entity or a professional organization. In some instances, system 140 may assign a higher level of trust to an individual certified to practice law, medicine, or public accounting within a state or unit of local government than to an individual merely associated with user 110 within a social network. Further, in other aspects, a public of private source may include an individual disposed in a position of public trust (e.g., law enforcement or local government administration), or an individual whose background has been closely scrutinized and vetted by a governmental entity (e.g., an individual possessing a govern-issued security clearance). System 140 may, for example, assign a higher level of trust to such individuals than to a business entity whose employees provide goods and/services to user 110 (e.g., employees of a Starbucks™ location from which user 110 purchases coffee).

In certain aspects, system 140 may weigh one or more public or private sources of non-credentialed information based on public certifications associated with the sources, positions of public trust held by the sources, and/or levels of governmental scrutiny applied to the sources. For example, system 140 may identify ten public sources of non-credentialed information connected to user 110 through various social networks. Based on the information identifying the public sources, system 140 may be configured to execute software processes that determine three of the identified public sources are certified to practice law in the state of New York (e.g., using digital activity data indicative of a LinkedIn™ profile of the identified public sources). In some instances, system 140 may assign a higher level of trust to the three identified attorneys than to the remaining seven individuals linked to user 110 through social networks (e.g., the financial institution may trust a guarantee provided by the three attorneys linked to user 110 more than a guarantee provided by the individuals known to user 110 through the social network).

In one embodiment, a public or private source may be trusted by the financial institution and designated by system 140 as a potential guarantor if that public or private source has an established relationship with the financial institution associated with system 140. For example, if user 110 were to identify an individual as a public source of non-credentialed information, and system 140 were to determine that the individual is an existing customer of the financial institution, system 140 may designate the individual as a potential guarantor. Further, for example, system 140 designate an individual identified by user 110 as a potential guarantor when that individual is an employee of the financial institution, a vendor of the financial institution, or is otherwise professionally related to the financial institution (e.g., outside legal counsel). In certain aspects, the financial institution may deem the individual's guarantee more trustworthy based on the existence of the professional relationship between the individual and the financial institution.

In other instances, a duration of a relationship between user 110 and a public or private source may be indicative of a level of trust placed in the public or private source by the financial institution. For example, system 140 may designate a public or private source as a guarantor of user 110's identity if the user 110's social network activity indicates that the public or private source has known user 110 for a threshold period of time (e.g., based on a duration of the relationship between user 110 and the public or private source). System 140 may determine the duration of the relationship based on, among other things, an analysis of social networking events featuring both user 110 and the public or private source (e.g., posted pictures in which both user 110 and the public or private source are tagged, posts or tweets mentioning both user 110 and the public or private source).

In further embodiments, a public or private source may be removed from consideration as a potential guarantor if the public or private source represents a risk of fraud. For example, and as described herein, user 110 may provide contact information of a public source that includes, but is not limited to, a telephone number, an email address, and a mailing address. In some instances, a source whose phone number corresponds to a prepaid cell phone (e.g., a “burner” cell phone), or whose email address is provided by a publicly available email service (e.g., Yahoo! and/or Outlook.com) may be disqualified from consideration as a potential guarantor unless more reliable contact information is available.

In further embodiments, system 140 may designate the public and/or private source as a potential guarantor of user 110's identify, when that public and/or private source previously verified identifies of one or more prior users to the financial institution. By way of example, system 140 may be configured to maintain data records within data repository 144 identifying one or more individuals (e.g., prior guarantors) that previously verified user identities to the financial institution. For example, and in response to a prior verification by an individual, system 140 may establish the individual as a prior guarantor, and may store information identifying the individual (e.g., name, email, social-networking identifiers, etc.) as prior guarantor data within a portion of data repository 144. Further, in additional aspects, system 140 may establish the individual as a prior guarantor in response to a “successful” verification of a user's identify by the individual, i.e., when that the user later verifies his or her identity to the financial institution using appropriate credentialed information (e.g., upon receipt of government-issued identification, etc.).

In certain aspects, system 140 may be configured to access the stored prior guarantor data (e.g., within data repository 144), and compare all or a portion of the public and private sources of non-credential information (e.g., as identified in steps 212 and 214, above) against the stored prior guarantor data. Based on the comparison, system 140 may identify public and/or private sources of non-credentialed information that previously identified user identities to the financial institution. In some aspects, system 140 may establish the one or more of the identified public and/or private sources (e.g., which previously identified users identities to the financial institution) as a potential verifying entity capable of guaranteeing and verifying user 110's identity to the financial institution (e.g., in step 216).

Further, in some aspects, system 140 may modify the stored prior guarantor data to include information identifying a number of verifications associated with each prior guarantor and/or dates associated with a last verification. In an embodiment, system 140 may be configured to curate the prior guarantor data at regular or predetermined intervals to delete data records identifying individuals whose last verification falls outside of a predetermined temporal window and additionally or alternately, individuals that verified more than a threshold number of users within the predetermined temporal window. Further, in additional embodiments, system 140 may also delete portions of the stored prior guarantor data corresponding to individuals whose identities were verified by non-credentialed information provided by other individuals acting as prior guarantors (e.g., and having identifying information stored within the prior guarantor data). In some aspects, by filtering the prior guarantor data in accordance with verification dates, numbers of verifications, and/or verification status, system 140 may maintain a list or reliable and neutral guarantors capable of accurately vouching for an identify of a requesting user. Further, the exemplary filtration processes described above may reduce a likelihood that malicious entities fraudulently access or hack the system 140 through daisy-chained attacks, i.e., a continuous use of the disclosed non-credentialed authentication processes by various individuals to fraudulently verify the identity of one or more individuals in an attempt to access system 140.

Further, and as described above, system 140 may be configured to receive and/or maintain positional data indicative of current geographic positions of client device 104 (e.g., and thus of user 110). The maintained positional data may also include geographic locations of devices associated with individuals known to or having a relationship with the financial institution (e.g., customers of the financial institution, employees of the financial institution, employees of vendors and other business entities contracted to provide services to the financial institution, etc.). In some aspects, system 140 may be configured to access the maintained positional data (e.g., as stored within data repository 144), and determine current geographic locations associated with at least a portion of the public and/or private sources of non-credentialed information (e.g., as identified in steps 212 and 214, above). System 140 may, in certain aspects, be further configured to determine that the current geographic locations of a subset of the public and/or private sources fall within a predetermined threshold distance (e.g., one meter, two meters, etc.) of the current geographic position of user 110. In an embodiment, system 140 may be configured to establish the subset of the public and/or private sources as potential verifying entities capable of guaranteeing and verifying user 110's identity to the financial institution (e.g., in step 216).

Further, and as described above, system 140 may also be configured to generate and maintain transaction data associated with user 110 and/or additional customers of the financial institution (e.g., as stored within data repository 144). In certain aspects, based on the stored transaction data, system 140 may determine that user 110 and at least one of the public and/or private sources initiated purchase transactions from a common retailer during a pre-determined temporal window prior to user 110s request for the financial services transaction, as described above. Further, and as described above, system 140 may also be configured to determine that user 110 and the at least one public and/or private source initiated the purchase transactions within a threshold time period of each other during the pre-determined temporal window. In response to these determinations, system 140 may, in an embodiment, be configured to identify the at least public and/or private source of non-credentialed information as potential verifying entities capable of guaranteeing and verifying user 110's identity to the financial institution (e.g., in step 216).

Using any of the exemplary techniques described above, system 140 may designate a public or private source of non-credentialed information as a potential guarantor of user 110's identity based on factors that include, but are not limited to, a number and type of social media connections with user 110, relationships with the financial institution, positional data indicative of current geographic locations of the public or private source, prior transactions involving the public or private source, personal and professional characteristics of the public or private source, and/or a status of the public or private source as a prior guarantor. The disclosed embodiments are not limited to such exemplary factors, and in further embodiments, system 140 may designate public or private sources as verifying entities based on other factors, and further, based on some combination of the above criteria (e.g., duration of relationship between user 110 and the public or private source and an occupation of the public or private source).

In some embodiments, system 140 may designate in step 216 a specified number of the public and private sources as potential verifying entities. For example, the financial institution associated with system 140 may establish rules that require confirmation from a minimum number of non-credentialed verifying entities (e.g., five or more) before system 140 verifies user 110's identity. Thus, in this example, system 140 may identify in step 216 at least the minimum number of potential verifying entities from which to request confirmation of user 110's identity. By way of example, as described above, system 140 may select the specified number of verifying entities from the public and private sources based on characteristics of connections between user 110 and the public and private sources (e.g., a number of social media connections, a type of social media connection, a duration of a relationship, etc.), and further, based on a level of trust assigned to the public and private sources (e.g., based on relationships between the financial institution and the public and private sources, etc.).

Further, in additional aspects, the specified number of verifying entities may vary depending on a level of trust assigned to the verifying entities by system 140. By way of example, system 140 may verify user 110's identity based on guarantees received from a first number of highly trusted potential verifying entities (e.g., three potential verifying entities), a second number of potential verifying entities assigned an average level of trust (e.g., five potential verifying entities), and a third number of potential verifying entities deems less trustworthy by system 140 (e.g., ten potential verifying entities). This disclosed embodiments are not limited to such exemplary number of potential verifying entities, and in other embodiments, system 140 may identify any number potential verifying entities from the public and private sources having any assigned level of trust, as would be appropriate to the financial institution and to system 140.

In other aspects, the financial institution may establish rules that require system 140 to select, as potential verifying entities in step 216, one or more public sources of non-credentialed information (e.g., as identified by user 110) and one or more private sources of non-credentialed information (e.g., as identified by system 140). By way of example, user 110, via client device 104 may identify three individuals that are connected to user 110 and are “friends” within Facebook™ (e.g., in step 212). Further, based on an address of user 110 specified in the received request, system 140 may be configured to identify one or more additional individuals that are customers of the financial institution and that live in user 110's apartment building. System 140 may, for example, identify as potential verifying entities the three individuals identified by user 110 (e.g., public sources) and the one or more customers that reside in the same apartment building as user 110 (e.g., private sources). In some aspects, the selection of potential verifying entities from both public and private sources of non-credentialed information may balance any inherent bias of the public sources towards user 110, thus providing for a more accurate verification of user 110's identity.

At step 218, system 140 may generate messages requesting that the potential verifying entities provide non-credentialed information that confirms user 110's identity, and may transmit the generated messages to the potential verifying entities across network 120 using any of the communication protocols outlined above. In some aspects, system 140 may be configured to transmit a message to a potential guarantor via email using an email address provided by user 110 and/or published on a social media account associated with the guarantor. In other aspects, system 140 may be configured to provide the generated message to the potential guarantor via text message using a telephone number provider by user 110, and additionally or alternatively, via a messaging functionality of a social network through which the potential guarantor is connected to user 110. Further, as described above, the potential guarantor may be an existing customer of the financial institution, and system 140 may provide the generated message to the potential guarantor via a mode of electronic communications designated by the financial institution. The potential guarantor may, in some aspects, access the generated message using a corresponding device (e.g., by accessing an email application or social media application executed by the corresponding device), and provide the requested confirmation (or lack thereof), which the potential guarantor's device may transmit to system 140 using any of the communications protocols outlined above.

In some embodiments, system 140 may generate a message to a potential guarantor in step 218 that includes an image of user 110 and user 110's name, and further, that requests confirmation of user 110's identity from the potential guarantor. By way of example, the non-credentialed information provided by the potential guarantor may confirm that the potential guarantor knows user 110, and further, that the included image is representative of user 110.

Further, in some aspects, the generated message may include non-credentialed information identifying user 110, such as age, address, and/or employer, and may request that the potential guarantor confirm that the provided non-credentialed information is accurate to the best of the potential guarantor's knowledge. Further, in other aspects, the generated message may prompt the potential guarantor to provide further elements of non-credentialed information describing user 110 (e.g., the age, address, employer, occupation, and/or former address of user 110), such that system 140 may determine whether the non-credentialed information provided by the potential guarantor matches the stored information accessible to system 140.

In additional aspects, a message generated for a potential guarantor may prompt the potential guarantor to provide elements of non-credentialed information that are specific to the potential guarantor's knowledge of or relationship with user 110. By way of example, the generated message may ask the potential guarantor whether he or she is connected to user 110 within a social network, and if so, to identify the social network. In additional aspects, the user 110 may be tagged in an image posted to an Instagram™ account of the potential guarantor, and the generated message may request that the potential guarantor provide information specific to the tagged image. Further, for example, system 140 may determine that user 110 and the potential guarantor live on a common floor of an apartment building, and the generated message may ask the potential guarantor if he or she has observed user 110 within the apartment building. In other aspects, system 140 may determine that the potential guarantor and user 110 work at a common employer, and the generated message may ask the potential guarantor if the potential guarantor works with user 110.

Further, in certain aspects, system 140 may be configured to include, within the generated message, information that requests a potential guarantor to provide personal or professional information describing user 110 that system 140 could subsequently confirm with a third-party data provider (e.g., a social-networking system, a data repository provided by a governmental entity, etc., accessible to system 1490 across network 120 through a corresponding API). For example, based on information identified within user 110's LinkedIn™ profile, system 140 may determine that user 110 and the potential guarantor worked within a common group at a common employer between 2010 and 2013. Further, by parsing data obtained from user 110's LinkedIn™ profile, system 140 may determine that user 110 worked on a particular project during that time period, and may include, within the generated message, information requesting the potential guarantor to identify the project on which user 110 worked between 2010 and 2013. Additionally or alternatively, system 140 may determine, based on an accessed Facebook™ profile of user 110, that a social-networking relationship exists between user 110 and a potential guarantor since 2012, and during that period, user 110's employment location changed three times. In some instances, system 140 may include within the generated message information requesting that the potential guarantor identify one user 110's prior addresses between 2012 and the current date.

In some aspects, upon receipt of the potential guarantor's response (e.g., from client device 104 across network 120), system 140 may be configured to query portions of stored data (e.g., as extracted from user 110's social media profiles, etc.) to determine the accuracy of the potential guarantor's response, as described below. In other aspects, and as described below, system 140 may perform one or more operations that access an application programming interface (API) associated with a third-party data provider (e.g., a system that provides social-media fees to subscribing systems, a data repository provided by a governmental entity, etc.) to request information confirming the accuracy of the potential guarantor's response. In other instances, as described above, system 140 may generate a message for a potential guarantor that is linked to user 110 through one or more social networks, and further, that is associated with a client device disposed within a predetermined distance of client device 104. In some instances, the generated message may include an image of user 110 and other information associated with user 110, and upon rendering by the client device of the potential guarantor, may prompt the guarantor to provide input to the client device indicating whether the potential guarantor observes user 110 in the crowd. In some aspects, the generated message may also identify an approximate position of user 110 (e.g., to the right of the potential guarantor). Further, in other aspects, if the potential guarantor provides input indicating that he or she observes user 119, the client device may present and additional interface to the potential guarantor requesting that the potential guarantor verify one or more detailed of their relationship with user 110 (e.g., information identifying a social network, etc.).

In further aspects, system 140 may generate a message for a potential guarantor linked to user 110 through one or more purchased transactions initiated at a common merchant or merchants within a threshold time period during a predetermined temporal window. For example, based on transaction data maintained by data repository 144, system 140 may determine that user 110 and a potential guarantor initiated purchase transactions at a local Starbucks™ location during a five-minute time period (e.g., within the threshold time period) on June 30^{th} (e.g., within a one-day temporal window prior to a July 1^{st} request for financial services transactions). In one embodiment, the generated message may include an image of user 110 and other information associated with user 110, and upon rendering by the client device of the potential guarantor, may prompt the guarantor to provide input to the client device indicating whether the potential guarantor observed user 110 when purchasing coffee on June 30^{th}. Additionally or alternatively, the generated message, upon rendering by the client device of the potential guarantor, may prompt the potential guarantor to provide input to the client device identifying one or more products purchased by user 110 during the visit to the local Starbucks™ location on June 30^{th}

In other aspects, system 140 may communicate with and transmit messages to potential verifying entities through a trusted network (e.g., an Automated Teller Machine (ATM) network, a point-of-sale (POS) network, etc.) when the potential guarantor engages in transactions with the financial institution. For example, a potential guarantor may be a customer of the financial institution, and may access an ATM machine using a debit card and corresponding PIN. In some instances, system 140 may be configured to store one or more generated message in a data store (e.g., data repository 144 of FIG. 1), may be configured to detect that the potential guarantor has accessed the ATM machine, and may be configured to perform software processes that deliver the one or more stored messages to the accessed ATM. The accessed ATM may, for example, be configured to render the received messages for presentation to the potential guarantor, who may review the transmitted information and confirm or deny the identity of user 110. Although delaying the confirmation of user 110's identity (e.g., the potential guarantor may infrequently access the ATM), the delivery of the generated messages across the trusted ATM network may, in some aspects, provide a secure and mechanism for authenticating the potential guarantor (e.g., based on the combination of a debit card and PIN).

In some embodiments, as described above, system 140 may identify a business entity as a potential guarantor of user 110's identity. For example, user 110 may regularly purchase coffee from a particular Starbucks™ location, and may identify the employees of the particular Starbucks™ location as public sources of non-credentialed information (e.g., in step 212). Additionally or alternatively, system 140 may access transaction data associated with user 110 (e.g., as stored within data repository 144 of FIG. 1), and may process the transaction data to determine that user 110 purchases lunch from particular Subway™ each day. System 140 may, for example, identify the employees of the particular Subway™ location as private sources of non-credentialed information (e.g., in step 214). In certain aspects, system 140 may identify the employees of the particular Starbucks™ and/or Subway™ locations as potential verifying entities of user 110's identity (e.g., in step 216), and may transmit messages to the particular Starbucks™ and/or Subway™ locations requesting that the employees confirm the identity of user 110 using or more of the techniques described above. For example, the generated messages may ask the employees to confirm that user 110 has purchased coffee from the particular Starbucks™ location.

In certain aspects, the financial institution associated with system 140 may establish a relationship with the business entity (e.g., the particular Starbucks™ and/or Subway™ locations), and may provide a financial incentive to the business entity upon receipt of a response to the confirmation request. By way of example, the financial institution may provide the financial incentive on a per-confirmation basis, and additionally or alternatively, on a regular basis (e.g., weekly or monthly) in exchange for unlimited confirmations. In other aspects, the business entity (e.g., the particular Starbucks™ and/or Subway™ locations) may apply a surcharge or fee to the next purchase made by user 110 after the requested confirmation by the business entity. For instance, user 110 may purchase coffee at the particular Starbucks™ location using a registered, prepaid card, and a point-of-sale (POS) device at the particular Starbucks™ location may be configured to recognize the user 110's card and apply the appropriate surcharge at the time of purchase.

In some embodiments, system 140 may receive responses from the one or more potential verifying entities (e.g., at step 220), and system 140 may be configured to identify a subset of the responses received from the potential verifying entities that comport with one or more requirements established by the financial institution and/or system 140 (e.g., in step 221). By way of example, the financial institution (e.g., business entity 150) may impose requirements on the received responses to increase a likelihood that the potential guarantors' responses to the transmitted messages (e.g., through input provided to corresponding devices) are based on their own knowledge and observations, and not based on communications with user 110 and/or independent research (e.g., by accessing and reviewing social media profiles of user 110 through client device 104),

In one aspect, the financial institution may establish and impose a timeliness requirement on each response received from the one or more the potential verifying entities. For example, the financial institution may require that the one or more potential verifying entities provide responses to the corresponding messages within a predetermined time period (i.e., a response time) after transmission by system 140. In certain aspects, the establishment and implementation of the predetermined response time by system 140 (e.g., in behalf of the financial institution) may increase a likelihood that the received responses are based on the personal knowledge and observations of the potential verifying identities, and not based on any post-message communications with user 110.

For example, system 140 may establish and assign (and store within corresponding portions of data repository 144) a five-minute response time to all messages generated by system 140 and transmitted to devices of corresponding potential verifying entities. In other instances, system 140 may adaptively determine a response time for one or more of the messages and/or the potential verifying entities based on, for example, a content of the message, an identity of a potential verifying identity, and characteristics of a relationship between user 110 and the potential verifying entity. For example, system 140 may establish a ten-minute response time for all messages transmitted to potential verifying entities known to user 110 (e.g., through a corresponding social network) for one year or less, and may establish a five-minute response time for messages transmitted to potential verifying entities know to user 110 for greater than five years. In additional aspects, system 140 may adaptively determine a response time for transmitted messages based on characteristics of devices associated with the potential verifying identities, and additionally or alternatively, based on a type of network through which these devices access the transmitted messages (e.g., a WiFi network, a trusted network, etc.). The disclosed embodiments are, however, not limited to the exemplary response times identified above, and in further embodiments, system 140 may establish any additional or alternate response time appropriate to the financial its security protocols, and to system 140.

In other aspects, system 140 may establish and impose one or more location-based restrictions on the responses received from the devices of the one or more potential verifying identities. For example, the financial institution may require that a potential verifying identity be disposed at least a threshold distance (e.g., 100 meters, etc.) from user 110 when providing a response to a message verifying user 110's identity. By way of example, and as described above, the responses received by system 140 may include positional information (e.g., in a header portion, a footer portion, etc.) identifying current geographic locations of devices associated with corresponding ones of the potential verifying identities. In certain aspects, in step 221, system 140 may be configured to extract the positional information from the received messages, compare the geographic locations of the potential verifying identities against a current geographic location of user 110 (e.g., as determined from stored positional information), and determine whether corresponding ones of the received responses comply with the location-based restrictions. The disclosed embodiments are, however, not limited to exemplary temporal and location-based restrictions, and in further embodiments, system 140 may impose any additional or alternate restriction on received responses appropriate to a risk tolerance of the financial institution and the messages.

Referring back to FIG. 2, in step 221, system 140 may be configured to identify at least a subset of the received responses that comply with the temporal and/or location-based restrictions imposed by the financial institution (e.g., to identify “compliant” responses). In further aspects, system 140 may determine whether to verify user 110's identity based on portions of the non-credentialed information within the identified compliant responses received from the potential verifying entities (e.g., in step 222). By way of example, the compliant responses received by system 140 in step 220 may include non-credentialed information that indicates the potential verifying entities confirm user 110's identity, or alternatively, are unable to confirm user 110's identity.

In some aspects, in step 222, system 140 may deem user 110's identity verified when the compliant responses from each of the potential verifying entities confirm the identity of user 110. In other aspects, system 140 may deem user 110's identity verified when the compliant responses from at least a threshold number of the potential verifying entities (e.g., 80% to 90% of the potential verifying identities) confirm the identity of user 110. In additional aspects, as the potential verifying entities may include a combination of public and private sources, system 140 may deem user 110's identity verified when at least a first threshold number of the public sources confirm user 110's identity, and when a second threshold number of the private sources confirm user 110's identity. System 140 may, for example, arbitrarily establish the threshold numbers of confirming potential verifying entities, adaptively determine the threshold numbers based on levels of trust assigned to the potential verifying entities, and/or adaptively determine the threshold numbers in accordance with the requested financial services transaction.

In certain aspects, system 140 may be configured to adaptively determine the threshold number of potential verifying identifies based on factors that include, but are not limited to, characteristics of the one or more potential verifying entities and a relationship between user 110 and the one or more potential verifying entities. For example, system 140 may be configured to establish a more stringent threshold number (e.g., close to 100%) for potential verifying identifies associated with user 110 through multiple social-networking relationships of extended duration. Additionally or alternately, system 140 may relax the threshold number (e,g., to 80% or 90%) for potential verifying identifies associated with user 110 through social-networking relationships of shorter duration. The disclosed embodiments are, however, not limited to these exemplary verification thresholds, and in further embodiments, system 140 may establish any additional or alternate verification threshold consistent with the risk policies of the financial institution and appropriate to the one or more potential verifying entities.

In other instances, system 140 may adaptively determine the threshold number of potential verifying identifies required to verify user 110's identity in accordance with characteristics of the financial services transaction (or transactions) requested by user 110. For example, in order to establish a registered account (e.g., a RSP), the financial institution may require that user 110 provide multiple elements of documentation verifiable through one or more government data repositories (e.g., by system 140 in communication with the corresponding data repository across network 120 and through an appropriate API). In some aspects, and in the absence of a portion of the required government documentation, system 140 may require that 100% of the potential verifying identifies verify user 110's identity prior to establishing the registered account. In other aspects, however, the financial institution may establish less stringent verification requirements (e.g., 80% to 90% of the potential verifying identifies verifying user 110's identity) for financial services transactions requiring fewer elements of documentation, such as funds transfers between accounts held by user 110 at the financial institution.

In further embodiments, the compliant responses received from the potential verifying entities may also confirm the identity of the user (as described above), and may also provide additional verification details, such as user 110's age, place of employment, and/or place of residence. In certain aspects, system 140 may process the received requests in step 222 to determine not only whether the potential verifying entities confirmed user 110's identity, but also whether the additional verification details correspond to stored information accessible to system 140 (e.g., within data repository 144 of FIG. 1). By way of example, in step 222, system 140 may determine that a potential guarantor confirms user 110's identity when the response indicates the potential guarantor's confirmation, and when a least a portion of the additional verification information matches the stored information, and additionally or alternatively, matches information obtained by system 140 from one or more third-party data repositories and sources of data (e.g., networked computer systems and data repository associated with government databases, social networks, etc.).

In other embodiments, system 140 may also identify one or more types financial services transactions available to user 110 based on the information provided within the received compliant responses. For example, if all of the potential verifying entities confirm the identity of user 110, then system 140 may allow user 110 to request and perform any of a number of financial services transaction services offered by the financial institution without limitation. Alternatively, if a threshold number (e.g., 75%) of potential verifying entities confirm the identity of user 110, system 140 may be configured to restrict user 110's ability to request the financial services transactions. Further, if fewer than a threshold number of potential verifying entities confirm the identity of user 110, then system 140 may deny user 110 access to the financial services provided by the financial institution. In one embodiment, system 110 may initially provide user 110 with restricted access to the financial services of business 120, but may provide user 110 with greater or full access to those financial services as the relationship between user 110 and the financial institution grows (e.g., in duration or value).

If system 140 were to verify the identity of user 110 based on the non-credentialed information (e.g., step 222, YES), system 140 may communicate the decision to user 110 (e.g., in step 224). For example, in step 224, system 140 may transmit information confirming the verification of user 110's identity to client device 104, which may render the received information for presentation to user 110 within a corresponding web page or online portal. In other aspects, system 140 may generate an email or text message that conveys the verification to user 110, and may transmit the generated email or text message to client device 104. Further, system 140 may also link information identifying the verification to user 110, and store the linked information within one or more data stores (e.g., data repository 144 of FIG. 1).

In step 225, system 140 may be configured to execute software processes that establish the requested checking account in response to the successful verification of user 110's identity, and store information identifying the account within one or more data storages (e.g., within data repository 144). Upon performance of the requested financial service, system 140 may generate and transmit a confirmation to client device 104 that confirms the establishment of the checking account and provides user 110 with information associated with the performed service (e.g., an account number and a routing number of the established checking account). Exemplary process 200 is then complete in step 208.

In some aspects, system 140 may be configured to establish the checking account automatically upon verifying user 110's identity and without addition input from user 110. In other aspects, system 140 may delay the establishment of the requested checking account until system 140 receives data from client device 104 confirming user 110's intention to utilize the requested service (e.g., in response to the communication transmitted by system 140 in step 224). Further, in some embodiments, the financial institution may subject a requested financial services transaction to additional requirements beyond identity confirmation (e.g., a background check and/or a credit check), and system 140 may delay the performance of the requested financial services transaction until receipt of the information identifying a satisfaction of the additional requirements. In additional aspects, and as described above, system 140 may be configured to modify a portion of the stored guarantor list to include one or more of the potential verifying identifies, and additionally or alternatively, to update numbers of successful verifications and/or dates of last successful verifications associated with individuals already included within the stored guarantor list.

In other aspects, system 140 may restrict or limit user 110's rights to access and utilize the new checking account established in step 225. By way of example, upon opening the new account, system 140 may establish time period during which user 110 must provide credentialed information to a physical branch of the financial institution. In some aspects, if user 110 fails to provide the credentialed information during the established time period, system 140 may suspend user 110's ability of electronically access the checking account and/or withdraw funds. In other aspects, system 140 may limit an ability of user 110 to withdraw funds from the established checking account, and additionally or alternatively, limit a number or value of transactions involving the established account, until user 110 provides the necessary credentials to the physical branch of the financial institution.

Referring back to step 222, if system 140 were unable to verify the identity of user 110 using the responses from the potential verifying entities (e.g., step 222; NO), system 140 may communicate the failed verification to user 110 (e.g., in step 226). For example, in step 226, system 140 may transmit information confirming the failed verification of user 110's identity to client device 104 using any of the techniques described above, which may render the received information for presentation to user 110. The transmitted information may, in other aspects, prompt user 110 to visit a physical branch of the financial institution to present additional elements of credentialed information (e.g., government-issued identification and/or proofs of residence), and additionally or alternatively, submit additional sources of non-credentialed information for verification by system 140. Exemplary process 200 is then complete in step 208. In the embodiments described above, reference is made to techniques that verify user 110's identity in response to a request from user 110 to open a new checking account at a financial institution. The disclosed embodiments are, however, not limited to such exemplary financial services transactions, and in additional embodiments, system 140 may verify user 110's identity in response to a request for any of a number of additional financial services transactions, which include, but are not limited to, an establishment of a savings, investment, and/or brokerage account, an establishment of a registered account, an application for credit, a transfer of funds between financial accounts (e.g., checking, savings, investment, etc.), a deposit or withdrawal of funds, a purchase or sale of a financial instrument or security, a purchase or sale of goods or services, or a payment of a bill. Further, in some aspects, the verification of user 110, and the threshold numbers of positive confirmations received from potential verifying entities, may vary depending on the specific financial services transaction requested by user 110.

Further, in certain embodiments (described above), system 140 may verify user 110's identity based on the personal knowledge and observations of one or more potential verifying entities. In other aspects, however, system 140 may be configured to provide, to a device associated with at least one potential identity, a message instructing the at least one potential verifying identity to query one or more third-party data repositories to obtain information facilitating system 140's verification of user 110's identity. In response to the instructions, the potential verifying entity may provide input to the corresponding device that enables the corresponding device to provide, to a system of the third-part data repository (e.g., through a corresponding API), a query requesting the information. For example, a device of a potential verifying identity may render a received message for presentation that instructs the potential verifying identity to query a local government database to obtain user 110's address in 2012. The corresponding device may receive at least a portion of the requested information from the system of the third-party data repository, and in response to input provided to the corresponding device by the potential verifying entity, may transmit the portion of the requested information to system 140 across network 120 as a response to the message. In some aspects, system 140 may receive the portion of the requested information, which system 140 may compare against comparable information obtained from the third-party-repository system and determine whether to validate user 110 using any of the exemplary techniques described above.

Furthermore, and as described above system 140 may be configured to perform operations that implement one or more of the exemplary techniques for non-credentialed authentication in response to a determination that user 110 lacks sufficient credentialed information to perform a requested financial services transactions. This disclosed embodiments are not limited to these exemplary implementations, and in further embodiments, system 140 may implement one or more of the exemplary non-credentialed authentication techniques as an additional or alternate step in a process for performing a requested financial services transaction. For example, to establish some accounts, a financial institution may require that user 110 provide specific sets of government-issued documentation, which system 140 may verify through queries to an appropriate data repository provided by a governmental entity (e.g., using any of the techniques outlined above). As an additional requirement to perform some financial services transactions, the financial institution may require that user 110 be associated with a favorable credit report received from a reporting agency (e.g., as provided by Equifax™, etc.). In certain aspects, and consistent with the disclosed embodiments, system 140 may be configured to perform operations that implement one or more of the exemplary non-credentialed authentication techniques outlined above as an alternative to obtaining the credit report from the reporting agency, which the financial institution may require to establish the requested account. By way of example, the financial institution's acceptance of an outcome of the exemplary non-credentialed authentication techniques outlined above may enable the financial institution to provide various services to new customers and other-under-banked cohorts who may possess credentialed information and funding, but who may lack a an appropriate credit history.

Moreover, and as described above, the disclosed embodiments enable a system associated with a financial institution (e.g., system 140 of business entity 150) to securely authenticate an identity of a user (e.g., user 110) based on public and private sources of non-credentialed information. These exemplary non-credentialed authentication techniques address and solve problems associated with conventional non-credentialed authentication techniques (e.g., authentication based on social-media information). For example, by imposing temporal and location-based restrictions on responses to requests for non-credentialed information, the disclosed embodiments increase a likelihood that that the responses are based on personal knowledge and observation of the potential verifying entities, and not based on research and/or communication with user 110. Further, in some instances, by filtering public and private sources of non-credentialed information against the prior guarantor data described above, the disclosed embodiments reduce an ability of hackers and other parties to fraudulently access or “hack” into system 140 through malicious daisy-chain attacks. Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. A system, comprising:
a storage device; and
at least one processor coupled to the storage device, the storage device storing instructions for controlling the at least one processor when executed by the at least one processor, the at least one processor being operative with instructions to:
receive a request for a financial services transaction from a device of a first user;
in response to the received request, determine whether the first user is associated with predetermined credentialed information corresponding to the financial services transaction;
if the user fails to be associated with the predetermined credentialed information, identify one or more second users having knowledge of the first user;
transmit, to devices of the one or more second users, one or more messages requesting non-credentialed information associated with the first user;
receive, from the second user devices, responses to the transmitted messages that include the non-credentialed information; and
determine whether to verify the identity of the first user based on at least a portion of the received non-credentialed information.

2. The system of claim 1, wherein the at least one processor is further configured to:
identify one or more of the received responses that comply with at least one of a temporal restriction or a location-based restriction; and
verify the identity of the first user based on portions of the non-credentialed information included within the one or more identified responses.

3. The system of claim 2, wherein:
the temporal restriction corresponds to a threshold response time; and
the at least one processor is further configured to:
determine response times corresponding to the received responses;
identify a subset the received responses having corresponding response times that fall within the threshold response time; and
verify the identity of the first user based on portions of the non-credentialed information included within the subset of the responses.

4. The system of claim 2, wherein:
the location-based restriction corresponds to a threshold displacement between the first user device and corresponding ones of the second user devices; and
the at least one processor is further configured to:
receive positional information from the a first and second position sensors, the first position sensor being included within the first user devices, and the second position sensors being included in corresponding ones of the second user devices;
detect, based on the positional information received from the first and second position sensors, that displacements between the first user device and corresponding ones of a subset of the second user devices exceed the threshold displacement;
verify the identity of the user based on portions of the non-credentialed information included within the responses received from the subset of the second user devices.

5. The system of claim 1, wherein the at least one processor is further configured to:
access guarantor data comprising one or more data records that identify third users, the third users being sources of non-credentialed information that verified one or more prior users;
determining, based on the guarantor data records, that the third users comprise at least a subset of the second users; and
transmit the one or more messages requesting non-credentialed information associated with the first user to the devices of the subset of the second users, the subset of the second users being corresponding ones of the sources of non-credentialed information that verified the one or more prior users.

6. The system of claim 5, wherein:
the guarantor data records include, for the third users, cumulative numbers of prior verifications and dates of at least one prior verification; and
the at least one processor is further configured to:
determine that at least one of (i) the cumulative number of prior verifications associated with a corresponding one of the third users exceeds a threshold value or (ii) the date of the at least one prior verification for the corresponding third user falls outside a temporal window; and
modify at least a portion of the guarantor data records to delete at least data record associated with the corresponding third user.

7. The system of claim 1, wherein the requested financial services transaction comprises at least one of an establishment of a checking, savings, investment, or brokerage account, an establishment of a registered account, an application for credit, a transfer of funds, a deposit or withdrawal of funds, a purchase or sale of a security, a purchase or sale of goods or services, a payment of a bill.

8. The system of claim 1, wherein the at least one processor is further configured to:
obtain, from the first user device, information identifying a plurality of candidate public sources of the non-credentialed information;
identify, based on an activity of the first user within one or more social networks, a number of members of the social networks connected to the first user and to a corresponding one of the candidate public sources;
determine whether he number of members exceeds a threshold value; and
when the number of members exceeds the threshold value, establish the corresponding candidate public source as one of the second users having knowledge of the first user.

9. The system of claim 1, wherein the at least one processor is further configured to:
obtain information identifying a plurality of candidate public sources of the non-credentialed information;
determine, based on the activity of the first user within one or more social networks, a relationship between the first user and a corresponding one of the candidate public sources; and
establish the corresponding candidate public source as one of the second users having knowledge of the first user based on at least one of (i) a duration of the determined relationship, (ii) a frequency of communications between the first user and the corresponding one of the candidate public sources, or (iii) a relationship type characterizing the relationship.

10. The system of claim 1, wherein the at least one processor is further configured to:
obtain information identifying a plurality of candidate public sources of the non-credentialed information;
identify a relationship between a corresponding one of the candidate public sources and a financial institution providing the requested financial services transaction, the relationship comprising at least one of a customer relationship, an employee relationship, or a vendor relationship;
assign, to the corresponding candidate public source, a level of trust based on the identified relationship; and
establish the corresponding candidate public source as one of the second users having knowledge of the first user based on the assigned level of trust.

11. The system of claim 10, wherein the at least one processor is further configured to assign the level of trust based on a professional certification of the corresponding candidate public source, the professional certification being issued by a governmental entity.

12. The system of claim 1, wherein:
the identified second users include one or more private sources of the non-credentialed information;
at least one of private sources is a customer or an employee of a financial institution providing the requested financial services transaction; and
the first user and at least one of the private sources share a common employer.

13. The system of claim 1, wherein the at least one processor is further configured to:
determine whether a threshold number of the responses from the second user devices provided valid non-credentialed information; and
designate the identity of the first user as verified, when at least the threshold number of the responses from the second user devices provided valid non-credentialed information.

14. The system of claim 13, wherein the at least one processor is further configured to establish the threshold number based on at least one of a characteristic of the first user, information characterizing a relationship between the first user and at least one of the second users, or information identifying the requested financial services transaction.

15. The system of claim 1, wherein the at least one processor is further configured to:
determine, based on the received non-credentialed information, whether a threshold number of the second users confirm the identity of the first user; and
designate the identity of the first user as verified, when the threshold number of second users confirm the first user identity.

16. The system of claim 15, wherein the at least one processor is further configured to establish the threshold number based on at least one of a characteristic of the first user, information characterizing a relationship between the first user and at least one of the second users, or information identifying the requested financial services transaction.

17. The system of claim 1, wherein the at least one processor is further configured to transmit, by the one or more processors, information denoting the identity of the first user as verified to the first user device.

18. A computer-implemented method, comprising:
receiving, by one or more processors, and from a device of a first user, a request for a financial services transaction;
in response to the received request, determining, by the one or more processors, whether the first user is associated with pre-determined credentialed information corresponding to the financial services transaction;
if the first user fails to be associated with the predetermined credentialed information, identifying, by the one or more processors, one or more second users having knowledge of the first user;
transmitting, to devices of the one or more second user by the one or more processors, one or more messages requesting non-credentialed information associated with the first user;
receiving, by the one or more processors, the non-credentialed information from the one or more second user devices in response to the transmitted messages; and
determining, by the one or more processors, whether to verify the identity of the first user based on at least a portion of the received non-credentialed information.

19. The method of claim 18, further comprising:
identifying, by the one or more processors, one or more of the received responses that comply with at least one of a temporal restriction or a location-based restriction; and
verifying, by the one or more processors, the identity of the first user based on portions of the non-credentialed information included within the one or more identified responses.

20. The method of claim 19, wherein:
the temporal restriction corresponds to a threshold response time; and
the method further comprises:
determining, by the one or more processors, response times corresponding to the received responses;
identifying, by the one or more processors, a subset the received responses having corresponding response times that fall within the threshold response time; and
verifying, by the one or more processors, the identity of the first user based on portions of the non-credentialed information included within the subset of the responses.

21. The method of claim 19, wherein:
the location-based restriction corresponds to a threshold displacement between the first user device and corresponding ones of the second user devices; and
the method further comprises:
receiving, by the one or more processors, positional information from the first and second position sensors, the first position sensor being included within the first user devices, and the second position sensors being included in corresponding ones of the second user devices;
based on the positional information received from the first and second position sensors, detecting, by the one or more processors, that displacements between the first user device and corresponding ones of a subset of the second user devices exceed the threshold displacement; and
verifying, by the one or more processors, the identity of the first user based on portions of the non-credentialed information included within the responses received from the subset of the second user devices

22. The method of claim 18, wherein the at least one processor is further configured to:
accessing, by the one or more processors, guarantor data comprising one or more data records that identify third users, the third users being sources of non-credentialed information that verified one or more prior users;
based on the guarantor data records, determining, by the one or more processors, that the third users comprise at least a subset of the second users; and
transmitting, by the one or more processors, the one or more messages requesting non-credentialed information associated with the first user to the devices of the subset of the second users, the subset of the second users being corresponding ones of the sources of non-credentialed information that verified the one or more prior users.

23. The method of claim 22, wherein:
the guarantor data records include, for the third users, cumulative numbers of prior verifications and dates of at least one prior verification; and
the method further comprises:
determining, by the one or more processors, that at least one of (i) the cumulative number of prior verifications associated with a corresponding one of the third users exceeds a threshold value or (ii) the date of the at least one prior verification for the corresponding third user falls outside a temporal window; and
modifying, by the one or more processors, at least a portion of the guarantor data records to delete at least data record associated with the corresponding third user.

24. The method of claim 18, wherein the requested financial services transaction comprises at least one of an establishment of a checking, savings, investment, or brokerage account, an establishment of a registered account, an application for credit, a transfer of funds, a deposit or withdrawal of funds, a purchase or sale of a security, a purchase or sale of goods or services, or a payment of a bill.

25. The method of claim 18, wherein the identifying comprises:
obtaining, from the first user device, information identifying a plurality of candidate public sources of the non-credentialed information;
identifying, based on an activity of the first user within one or more social networks, a number of members of the social networks connected to the first user and to a corresponding one of the candidate public sources;
determining whether the number of members exceeds a threshold value; and
when the number of members exceeds the threshold value, establishing the corresponding candidate public source as one of the second users having knowledge of the first user.

26. The method of claim 18, wherein the identifying comprises:
obtaining information identifying a plurality of candidate public sources of the non-credentialed information;
determining, based on an activity of the first user within one or more social networks, a relationship between the first user and a corresponding one of the candidate public sources; and
establishing the corresponding candidate public source as one of the second users having knowledge of the first user based on at least one of (i) a duration of the determined relationship, (ii) a frequency of communications between the first user and the corresponding one of the candidate public sources, or (iii) a relationship type characterizing the relationship.

27. The method of claim 18, wherein the identifying comprises:
obtaining information identifying a plurality of candidate public sources of the non-credentialed information;
identifying a relationship between a corresponding one of the candidate public sources and a financial institution providing the requested financial services transaction, the relationship comprising at least one of a customer relationship, an employee relationship, or a vendor relationship;
assigning, to the corresponding candidate public sources, a level of trust based on the identified relationship; and
establishing the corresponding candidate public source as one of the second users having knowledge of the first user based on the assigned level of trust.

28. The method of claim 27, wherein the assigning comprises assigning the level of trust based on a professional certification of the corresponding candidate public source, the professional certification being issued by a governmental entity.

29. The method of claim 18, wherein:
the identified second users include one or more private sources of the non-credentialed information;
at least one of the private sources is a customer or an employee of a financial institution providing the requested financial services transaction; and
the first user and at least one of the private sources share a common employer.

30. The method of claim 18, wherein the determining comprises:
determining whether a threshold number of the second users provided valid non-credentialed information or confirmed the identity of the first user, the threshold number being established based on at least one of a characteristic of the first user, information characterizing a relationship between the first user and at least one of the second users, or information identifying the requested financial services transaction; and
designating the identity of the first user as verified, when at least the threshold number of the second users provided valid non-credentialed information or confirmed the identity of the first user.

31. The method of claim 18, further comprising transmitting, by the one or more processors to the first user device, information denoting the identity of the first user as verified.

32. A tangible, non-transitory computer-readable medium storing instructions that, when executed by at least one processor, cause the at least one processor to perform a method, comprising:
receiving, from device of a first user, a request for a financial services transaction;
in response to the received request, determining whether the first user is associated with pre-determined credentialed information corresponding to the financial services transaction;
if the first user fails to be associated with the predetermined credentialed information, identifying one or more second users having knowledge of the first user;
transmitting, to devices of the second users, one or more messages requesting non-credentialed information associated with the first user;
receiving the non-credentialed information from the one or more second user devices in response to the transmitted messages; and
determining whether to verify the identity of the first user based on at least a portion of the received non-credentialed information.
